(19) United States
(12) Patent Application Publication
(10) Pub. No.: US 2026/0083088 A1
(43) Pub. Date: Mar. 26, 2026

(54) COMPOSITE-STRUCTURED PET MAT

(71) Applicant: ABSORB FORTUNE LIMITED, Hong Kong (CN)

(72) Inventor: Yaguang Wu, Bengbu (CN)

(21) Appl. No.: 19/251,660

(22) Filed: Jun. 26, 2025

Related U.S. Application Data
(63) Continuation-in-part of application No. 18/894,319, filed on Sep. 24, 2024, now Pat. No. 12,364,247.

(51) Int. Cl. A01K 1/015; A01K 1/01; B32B 3/30; B32B 7/06

(52) U.S. Cl. CPC A01K 1/0157; A01K 1/0107; B32B 3/30; B32B 7/06; B32B 2250/02; B32B 2307/302; B32B 2307/304; B32B 2307/726; B32B 2307/7265; B32B 2471/04

(57) ABSTRACT

A composite-structured pet mat includes an upper layer and a lower layer separable from each other, where the upper layer is of an integral structure or formed by splicing or combining at least two functional units. The functional units include, but are not limited to, one or more of a waterproof unit, a water-absorbing unit, a heat-conducting unit, and a thermal insulation unit. The functional units are detachably connected to each other through at least one of magnetic fit, a snap-fit structure, a clamping component, or a reusable adhesive structure, thereby enabling partial replacement or functional recombination by the user according to behavior habits and body size of the pet, and seasonal changes. The pet mat is designed to have a detachable multi-layer structure, the lower layer is waterproof and stain-resistant, the upper layer is separately removed for cleaning, and functional zoning is flexibly adjustable.

### CROSS-REFERENCE TO RELATED APPLICATIONS

The present application is a Continuation in part of U.S. patent application Ser. No. 18/894,319, filed on Sep. 24, 2024.

### TECHNICAL FIELD

The present disclosure relates to the field of pet supplies, and in particular to a composite-structured pet mat.

### BACKGROUND

Defects of pet mats in the prior art are mainly reflected in three aspects, including functional limitations of single-layer structures, structural defects in composite designs, and inadequate response to dynamic needs. Single-layer feeding mats of the prior art employ non-detachable waterproof coatings or silicone materials, which effectively block liquid penetration, but require full-surface scrubbing to remove sticky food residues, and dense coatings impede penetration of cleaning agents into fibers, thereby resulting in bacterial proliferation due to organic residue accumulation. Experimental data demonstrates that prolonged use of pet mats results in microbial colonization levels exceeding safety thresholds microbial colonization levels exceed safety thresholds, and frequent scrubbing is insufficient for thoroughly eliminating organic contaminants infiltrated into micropores. Resting mats of an integral plush structure have enhanced thermal insulation, but tend to trap pet hair, and machine washing easily leads to fiber compaction and deformation. Moreover, the non-detachable design complicates cleaning and maintenance, and the users usually complain about difficulty of washing large mats inside washing machines, and mold growth is easily induced in the drying process.

Attempts are made in zoned designs of composite pet mats to achieve multifunctional integration, but fixed partition structures do not adapt to changes in pet behaviors. When multiple pets with significant size variations are raised together, the user cannot adjust area ratios of different functional areas according to actual needs, but can only purchase additional mats. In the lamination process, a waterproof membrane is permanently bonded to a base material, such that permeation channels are formed at seams. When liquid infiltrates into an interface between dissimilar materials, internal capillary action causes contaminant diffusion. Rigid splicing further induces material incompatibility, mold growth easily occurs after liquid absorption by plush areas, edges of adjacent waterproof areas curl up to form hard-to-clean corners, and the user has to replace the entire mat when surface damage occurs, because maintenance of an individual functional layer is not allowed.

An underlying cause of defects of pet mats in the prior art lies in that dynamic nature of pet behaviors is neglected. Secretions from canine paw pads accumulate on single-layer mat surfaces to form biofilms, microbial residues are hardly thoroughly eliminated through conventional cleaning methods, and non-detachable structures further impede implementation of deep-sanitization means such as high-temperature disinfection. Composite pet mats available on the market are provided with preset different functional areas, but material performance conflicts usually result in usage contradictions. For example, mold growth easily occurs after liquid absorption by plush areas, and edges of adjacent waterproof areas curl up to form hard-to-clean corners. Surface fabric wear necessitates replacement of the entire pet mat, and targeted repair of a damaged functional layer is not allowed, thereby increasing use costs and resource waste.

### SUMMARY

An objective of the present disclosure is to overcome at least one deficiency in the prior art and provide a composite-structured pet mat. The pet mat is designed to have a detachable multi-layer structure, the lower layer is waterproof and stain-resistant, the upper layer is separately removed for cleaning, and functional zoning is flexibly adjustable, which meets varying pet needs, extends service life, and reduces maintenance costs.

To achieve the above objective, the present disclosure discloses a composite-structured pet mat, and the pet mat includes an upper layer and a lower layer separable from each other, where the upper layer is of an integral structure or formed by splicing or combining at least two functional units; and a method for connection between the upper layer and the lower layer comprises but is not limited to at least one of magnetic fit, a snap-fit structure, a clamping component, a strap, or a reusable adhesive structure.

The functional units include, but are not limited to, one or more of a waterproof unit, a water-absorbing unit, a heat-conducting unit, and a thermal insulation unit, thereby enabling partial replacement or functional recombination by the user according to behavior habits and body size of the pet, and seasonal changes. The functional units are detachably connected to each other through at least one of magnetic fit, a snap-fit structure, a clamping component, or a reusable adhesive structure, such that localized replacement or functional recombination of the upper layer is achieved according to usage requirements.

A method for connection between the upper layer and the lower layer includes but is not limited to at least one of magnetic fit, a snap-fit structure, a clamping component, a strap, or a reusable adhesive structure.

Optionally, the lower layer is a waterproof layer with water-resistant properties.

Optionally, the upper layer and the lower layer are cooperatively magnetically connected. Specifically, magnetic elements with opposite magnetic polarities are arranged at corresponding positions of the upper layer and the lower layer for magnetic connection, and the magnetic elements include but are not limited to magnetic blocks, magnetic strips, or magnetic composite materials.

Optionally, the lower layer is made from a magnetic waterproof material, and a bottom of the upper layer is provided with a metal sheet or a magnetic element with a magnetic polarity complementary to that of the lower layer to achieve adsorptive fixation.

Additionally, optionally, the upper layer and the lower layer are cooperatively connected through a snap-fit structure, a plurality of slots and hook assemblies fitted with each other are arranged along edges of the upper layer and the lower layer, and multi-point snap-fit engagement achieves a cooperative connection between the upper layer and the lower layer.

To meet spatial separation needs, the upper layer and/or the lower layer is provided with a protrusion configured for spatial separation. The protrusion is designed to be a detachable partition strip and is fixed to the upper layer and/or the lower layer through embedded plug-in connection or adhesive bonding, such that the user flexibly adjusts the partition layout and the pet mat is divided into different functional areas.

In terms of material selection, the upper layer is made from one or more of fabric, silicone, a superabsorbent polymer, sponge, diatom mud, a natural fiber, and an artificial fiber. The lower layer is made from one or more materials including but not limited to silicone, a high-molecular polymer, leather, artificial leather, rubber, plastic, ethylene-vinyl acetate copolymer, polyvinyl chloride, a polyurethane-coated material, a waterproof textile material, polyethylene, and polypropylene, and the materials are used individually or in combination to achieve waterproof functionality of the lower layer.

In the design of protruding barrier rim, the upper layer is provided with a protruding barrier rim, and the protruding barrier rim is a continuously enclosed barrier configured to prevent liquid overflow and solid particle migration out of a pet mat area, or alternatively is a blocking structure arranged at a local position or in a specific direction.

Optionally, the upper layer or the lower layer is provided with a protruding barrier rim, and the protruding barrier rim is a continuously enclosed barrier configured to prevent liquid overflow and solid particle migration out of a pet mat area, or alternatively is a blocking structure arranged at a local position or in a specific direction.

Optionally, the protruding barrier rim is detachably arranged on the lower layer, and removal of the protruding barrier rim for cleaning or replacement is allowed.

Optionally, the protruding barrier rim is arranged on the lower layer and forms a circumferential constraint structure together with a bottom face of the upper layer, which is configured to fix relative positions of the upper layer and the lower layer and achieve a separable cooperative connection between the upper layer and the lower layer.

Support contact bodies that are spaced apart from each other are arranged on an upper surface of the lower layer, and support planes are formed at tops of the support contact bodies. The support contact bodies are elastic structures configured to achieve pressure cushioning and enhance comfort. The lower layer is provided with a continuously enclosed protruding barrier rim surrounding the support contact bodies, such that the lower layer has a certain liquid storage capacity.

The lower layer is made from a magnetic waterproof material, and a bottom of the upper layer is provided with a metal sheet or a magnetic element with a magnetic polarity complementary to that of the lower layer to achieve adsorptive fixation with the lower layer.

The upper layer and the lower layer are cooperatively connected through a snap-fit structure, a plurality of slots and hook assemblies fitted with each other are arranged along edges of the upper layer and the lower layer, and multi-point snap-fit engagement achieves a cooperative connection between the upper layer and the lower layer.

Compared with the prior art, the present disclosure has at least one of the following beneficial effects:
1. Convenient removal and cleaning: the detachable multi-layer structure allows separate removal of the upper layer for cleaning, and prevents accumulation of stains, thereby enhancing hygiene.
2. Flexible function adjustment: dynamic adjustment of functional area sizes and materials adapts to diverse pet sizes and seasonal changes.
3. Stable and convenient connection: magnetic connection, snap-fit connection, and other connections ensure stability and operability, and optimize assembly experience.
4. Reduced maintenance costs: design of independent layers allows separate replacement for localized damage, without need to discard the entire pet mat.
5. Adjustable shapes and proportions: breakthroughs in traditional rigid splicing support free adjustment of functional area shapes and proportions, and enhance applicability.

The beneficial effects and advantages listed above are not exhaustive. Other potential advantages and detailed embodiments will be further disclosed in the examples or other descriptions of the present disclosure.

### DESCRIPTION OF EMBODIMENTS

It should be noted that better understanding of various aspects of the present disclosure may be achieved after reading the following detailed embodiments with reference to the accompanying drawings, and positions, dimensions, and scales of structures shown in the drawings do not necessarily reflect actual positions, dimensions, and scales. Reference numerals in the figures:

FIG. 1 is a schematic structural diagram of Example 1 according to the present disclosure.

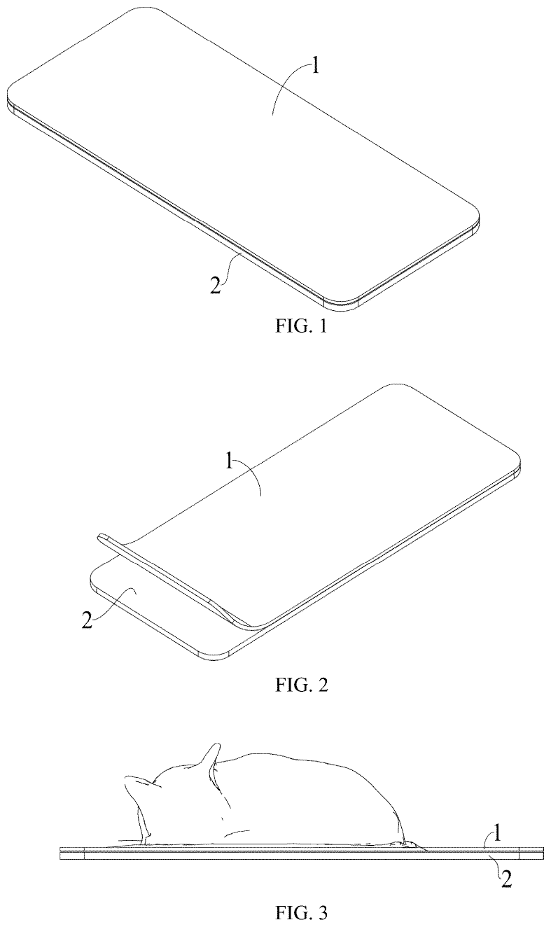

FIG. 2 is a schematic structural diagram of Example 1 in which an upper layer is partially lifted according to the present disclosure.

FIG. 3 is a use state reference diagram of a pet resting mat in Example 1 according to the present disclosure.

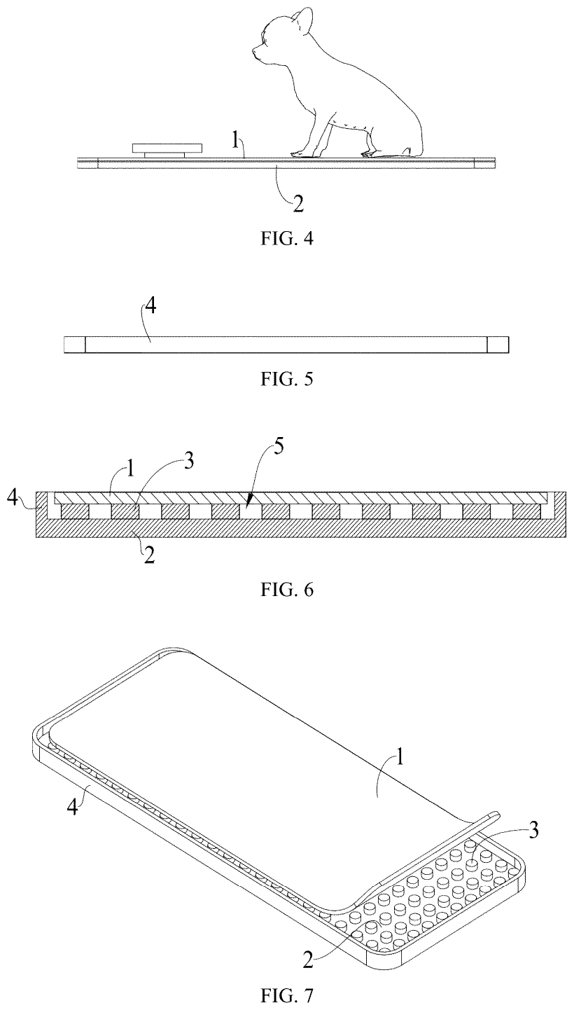

FIG. 4 is a use state reference diagram of a pet feeding mat in Example 1 according to the present disclosure.

FIG. 5 is a schematic structural diagram of Example 2 according to the present disclosure.

FIG. 6 is a schematic diagram of a sectional structure of Example 2 according to the present disclosure.

FIG. 7 is a schematic structural diagram of Example 2 in which an upper layer is partially lifted according to the present disclosure.

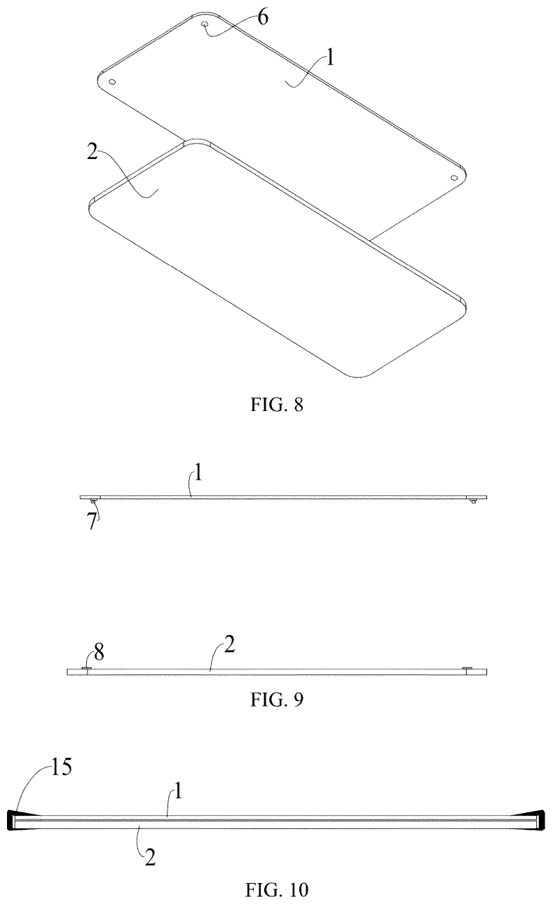

FIG. 8 is a structural exploded view of Example 3 according to the present disclosure.

FIG. 9 is a structural exploded view of Example 4 according to the present disclosure.

FIG. 10 is a structural exploded view of Example 5 according to the present disclosure.

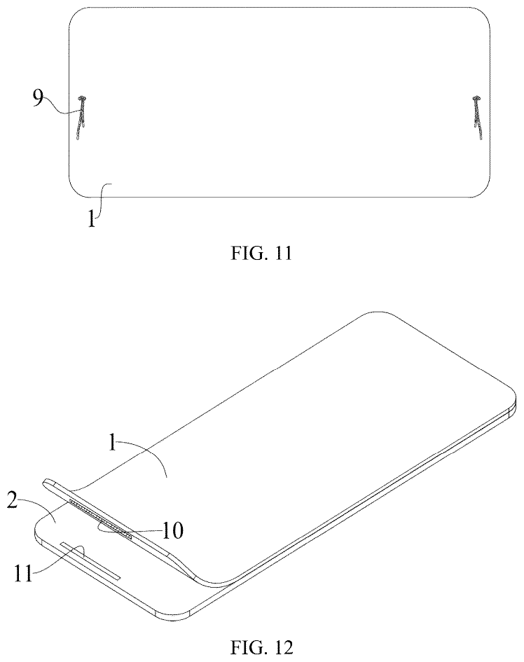

FIG. 11 is a schematic structural diagram of a top view of Example 6 according to the present disclosure.

FIG. 12 is a schematic structural diagram of Example 7 in which an upper layer is partially lifted according to the present disclosure.

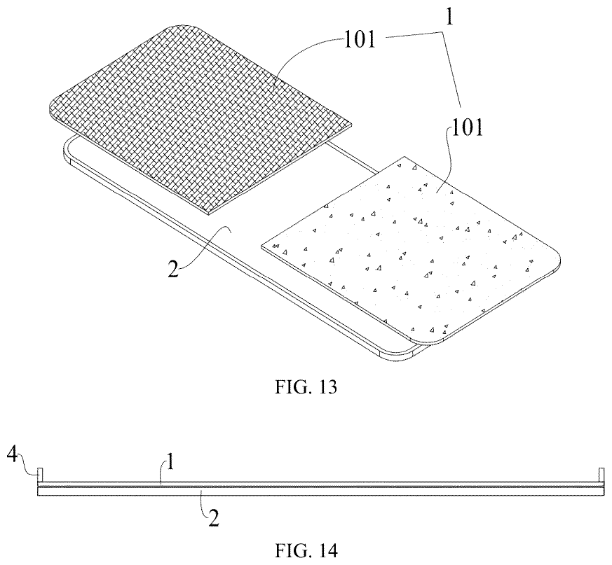

FIG. 13 is a structural exploded view of Example 8 according to the present disclosure.

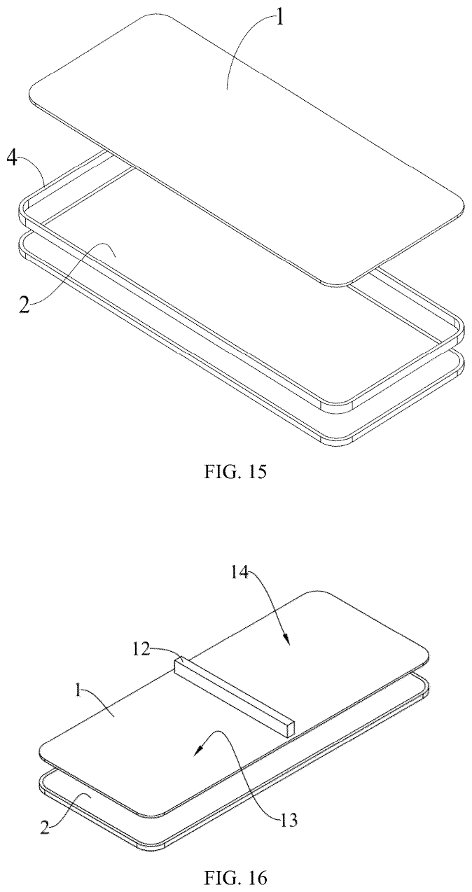

FIG. 14 is a schematic diagram of a sectional structure of Example 9 according to the present disclosure.

FIG. 15 is a structural exploded view of Example 10 according to the present disclosure.

FIG. 16 is a schematic structural diagram of Example 11 according to the present disclosure.

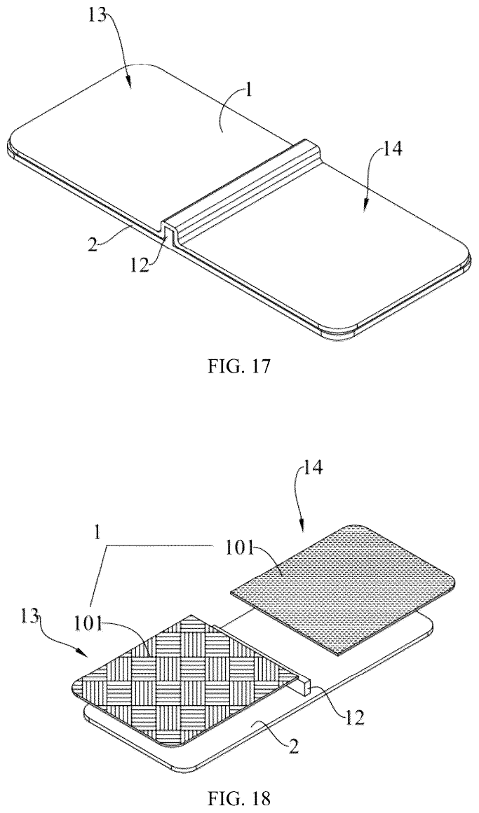

FIG. 17 is a schematic structural diagram of Example 12 according to the present disclosure.

FIG. 18 is a structural exploded view of Example 12 according to the present disclosure.

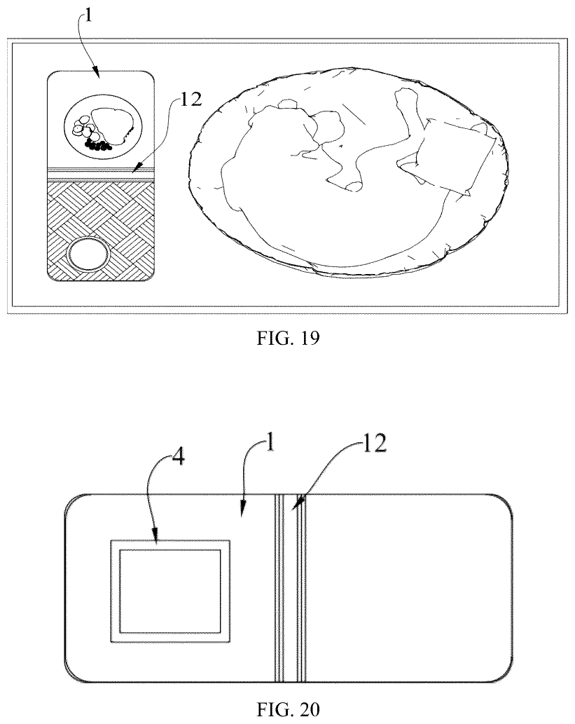

FIG. 19 is a schematic structural diagram of Example 13 according to the present disclosure.

FIG. 20 is a schematic structural diagram of an alternative structure of Example 13 according to the present disclosure.

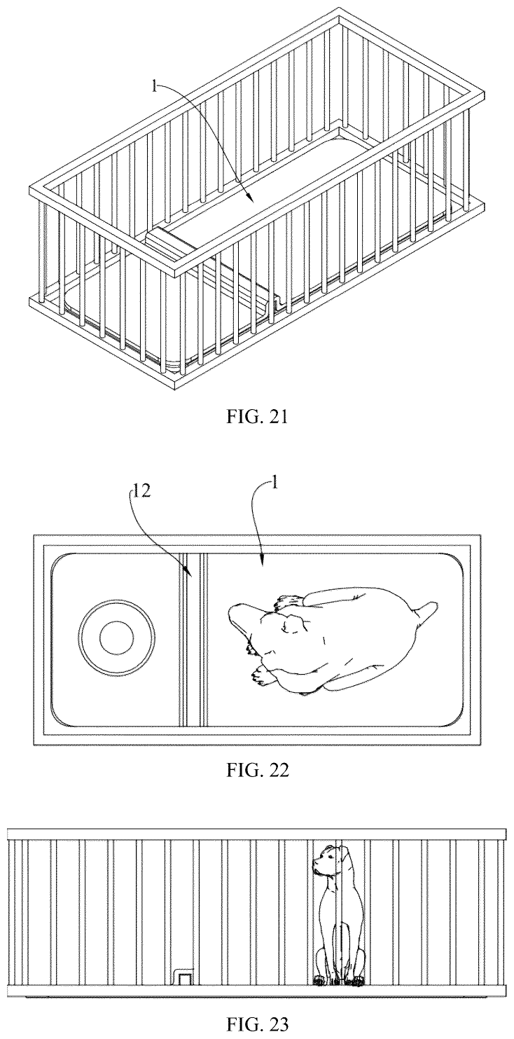

FIG. 21 is a use state reference diagram of Example 14 placed inside a pet enclosure according to the present disclosure.

FIG. 22 is a use state reference diagram of Example 14 according to the present disclosure.

FIG. 23 is a use state reference diagram of another view of Example 14 according to the present disclosure.

### DESCRIPTION OF EMBODIMENTS

### Example 1

With reference to FIGS. 1-4, a composite-structured pet mat is provided, and the composite-structured pet mat is designed to include an upper layer 1 and a lower layer 2 separable from each other. The upper layer 1 is independently removed for cleaning, and for example, cleaning thereof inside a washing machine is allowed. To meet different usage requirements, the upper layer 1 is made from various materials: as shown in FIG. 3, the upper layer 1 is made from a waterproof fabric material to meet requirements for a feeding mat, and for better use, a dish or a bowl containing food or water is typically placed on a surface of the upper layer 1, and in this case, the waterproof upper layer 1 effectively prevents liquid seepage; and as shown in FIG. 4, the upper layer 1 is alternatively made from plush fabric to meet requirements for a pet resting mat, which provides a soft and comfortable resting environment for a pet. Additionally, the upper layer 1 functions as a water-absorbing layer, for example, a disposable water-absorbing layer containing an absorbent material is stacked on the lower layer 2, and when the upper layer 1 is contaminated or saturated with water, the upper layer 1 is easily removed and replaced with a new one, thereby significantly enhancing usage flexibility and functional versatility of the pet mat.

The lower layer 2 functions as a foundational support structure for the entire pet mat and is made from a water-resistant material such as waterproof fabric, silicone, rubber, or plastic sheets, which effectively prevents liquid from penetrating to the floor, thereby maintaining a clean and dry environment.

### Example 2

With reference to FIGS. 5-7, in this example, the design of the lower layer 2 is significantly different. A plurality of support contact bodies 3 that are spaced apart from each other are arranged on an upper surface of the lower layer 2, and in specific implementation, the support contact bodies 3 directly protrude from the upper surface of the lower layer 2, or are fixed to the lower layer 2 through physical or chemical means by using a soft, elastic material such as silicone or foamed plastic. Such materials exhibit excellent elastic properties and deform when a pet steps or lies thereon, which absorbs impact and reduces pressure on joints of the pet, thereby enhancing comfort during use. Flat support planes at tops of the support contact bodies 3 evenly support the upper layer 1, thereby ensuring that the upper layer 1 remains stable and flat.

Additionally, in implementation, to cooperate with the support contact bodies 3, an outer edge of the lower layer 2 extends upward to form a protruding barrier rim 4. The protruding barrier rim 4 and the lower layer 2 are integrally formed.

It is understood that the support contact bodies 3 define an intermediate space 5 between the upper layer 1 and the lower layer 2, such that the lower layer 2 has a certain water storage capacity. When a small amount of liquid penetrates from the upper layer 1 to the lower layer 2, a dry state of the upper layer 1 is effectively preserved. Such liquid is temporarily stored in a spatial region of the intermediate space 5. Since the lower layer 2 is made from a waterproof material, further downward penetration of liquid is effectively prevented, thereby avoiding direct contact of the liquid with the floor.

It is further understood that in actual use, water is proactively injected into the intermediate space 5 to achieve temperature control of the upper layer 1 in a high-temperature environment.

### Example 3

With reference to FIG. 8, in this example, the upper layer 1 and the lower layer 2 are magnetically connected, which facilitates the assembly and disassembly of the pet mat and ensures a reliable and stable connection.

In specific implementation, magnetic elements 6 with opposite magnetic polarities are arranged at corresponding positions of the upper layer 1 and the lower layer 2, and the magnetic elements 6 are made of magnetic blocks, magnetic strips, magnetic composite materials, or the like. Through magnetic adsorption, a tight connection between the upper layer 1 and the lower layer 2 is achieved. The magnetic connection method not only facilitates operation, but also enhances connection strength, which effectively prevents the upper layer 1 from shifting or detaching during activities of the pet.

In actual use, when cleaning or replacement of the upper layer 1 is required, the user easily removes the upper layer 1 from the lower layer 2. Due to the non-destructive nature of the magnetic connection, frequent assembly and disassembly neither damage the connection structure nor cause connection loosening, which significantly facilitates maintenance of the pet mat and extends the service life thereof.

According to different usage scenarios and needs, the user quickly replaces the upper layer 1 with different functions such as a waterproof layer, a water-absorbing layer, a resting layer, or the like.

### Example 4

With reference to FIG. 9, in this example, the upper layer 1 and the lower layer 2 are connected in a snap-fitted manner, which facilitates the assembly and disassembly of the pet mat and ensures a reliable and stable connection.

In specific implementation, a plurality of slots 8 and hook assemblies 7 fitted with each other are arranged along edges of the upper layer 1 and the lower layer 2. Through multi-point snap-fit engagement, a tight connection between the upper layer 1 and the lower layer 2 is achieved. The snap-fit connection method not only facilitates operation, but also enhances connection strength, which effectively prevents the upper layer from shifting or detaching during activities of the pet.

The design of the snap-fit structure enables simple and quick assembly and disassembly, and the user only needs to apply an appropriate force to separate or combine the upper layer 1 and the lower layer 2. The tool-free connection method significantly facilitates maintenance of the pet mat and extends the service life thereof.

### Example 5

With reference to FIG. 10, in this example, the upper layer 1 and the lower layer 2 are cooperatively connected through use of clamping components 15. The core of this example lies in ensuring connection stability between the upper layer 1 and the lower layer 2 through the mechanical fastening function of the clamping components 15, which facilitates assembly and disassembly by the user.

In specific implementation, the clamping components 15 exist in the forms of clips, snap rings, or elastic clamping tabs, and the clamping components 15 are arranged along edges or side faces of the upper layer 1 and the lower layer 2. By means of elastic deformation or mechanical clamping of the clamping components 15, the upper layer 1 is securely fixed to the lower layer 2. The clamping components 15 are typically made from a somewhat strong and elastic material such as plastic, metal, or a reinforced composite material, to ensure reliability and durability of the clamping.

### Example 6

With reference to FIG. 11, the upper layer 1 and the lower layer 2 are detachably connected through use of straps 9 cooperatively. In this example, the bundling and securing effect of the straps 9 is leveraged to ensure connection stability between the upper layer 1 and the lower layer 2, which facilitates rapid assembly and disassembly by the user.

In specific implementation, the straps 9 exist in the forms of nylon hook-and-loop fasteners, cotton straps, or elastic cord straps, and the straps 9 are arranged along edges or side faces of the upper layer 1 and the lower layer 2. One end of each of the straps 9 is fixed to the upper layer 1, the other end thereof is fixed to the lower layer 2, and the upper layer 1 is securely fixed to the lower layer 2 through the bundling effect of the straps 9.

In actual use, the user easily installs or removes the upper layer 1 through straightforward operations. For example, to clean or replace the upper layer 1 as needed, the user only needs to loosen the straps 9 to easily remove the upper layer 1, and after cleaning or replacement, the upper layer 1 is re-fixed to the lower layer 2 through the straps 9.

### Example 7

With reference to FIG. 12, in this example, the upper layer 1 and the lower layer 2 are connected through use of a reusable adhesive structure such as a hook-and-loop fastener structure. In this example, an adhesive interaction between a hook surface 10 and a loop surface 11 of the hook-and-loop fastener is utilized to achieve a stable and detachable connection between the upper layer 1 and the lower layer 2, which facilitates rapid assembly and disassembly by the user.

In specific implementation, the hook-and-loop fastener structure is formed by the hook surface 10 and the loop surface 11 arranged at corresponding positions of the upper layer 1 and the lower layer 2. The hook surface 10 is typically made from a rigid nylon material with numerous tiny hook structures on a surface thereof; and the loop surface 11 is made from a softer nylon material with numerous fine fibrous loops on a surface thereof. When the hook surface 10 and the loop surface 11 come into contact with each other under an applied pressure, the hook structure engages with the fibrous loops to achieve secure adhesion. The hook surface 10 and the loop surface 11 are distributed in the forms of strips, patches, or dots, to meet different adhesive strength requirements and use demands.

In actual use, the user easily adheres the upper layer 1 and the lower layer 2 by simply pressing, and the adhesion process requires no additional tools, thereby ensuring convenient and efficient operations.

### Example 8

With reference to FIG. 13, in this example, the upper layer 1 is composed of two functional units 101. This design aims to achieve multifunctionality and operational flexibility of the pet mat through the combination of the two functional units 101.

In specific implementation, the two functional units 101 are designed according to different usage requirements. For example, one functional unit 101 is made from a waterproof fabric material, which is primarily configured for pet feeding scenarios to prevent permeation of food debris and liquid; and the other functional unit 101 is made from plush fabric or an absorbent material, which is configured for pet resting scenarios to provide a soft and comfortable resting environment for a pet. The two functional units 101 are mutually independent or detachably connected cooperatively through magnetic fit, a snap-fit structure, a clamping component, a reusable adhesive structure, or the like, thereby ensuring connection stability and disassembly convenience.

In terms of operating principle, during pet movement on the pet mat, the two functional units 101 leverage respective advantages. A waterproof unit effectively blocks liquid penetration, and protects the lower layer 2 and the floor from contamination; and an absorbent or thermal insulation unit provides a comfortable resting environment for the pet. The combinational design facilitates localized replacement by the user according to actual needs. For example, when the waterproof unit is contaminated, removal for cleaning or replacement is performed without need to replace the entire pet mat, thereby saving resources and usage costs.

Moreover, the combinational design of the two functional units 101 enhances the adaptability and practicality of the pet mat. The user is allowed to flexibly choose and combine different functional units according to behavior habits and body size of the pet, or seasonal changes. Such flexibility enables the pet mat to better adapt to diverse usage scenarios, thereby improving the living quality of the pet.

### Example 9

With reference to FIG. 14, in this example, the protruding barrier rim 4 is arranged along a circumferential edge of the upper layer 1. In this example, the design of the protruding barrier rim 4 effectively prevents liquid overflow and migration of solid particles out of the pet pad area, and enhances the structural integrity and use safety of the pet mat due to formation of a closed barrier.

In specific implementation, the protruding barrier rim 4 is made from a flexible material such as waterproof fabric or plastic sheets, and is generally approximately 3-10 cm high, which effectively prevents the overflow of liquid and solid particles.

In actual use, when the pet feeds or rests on the mat, the protruding barrier rim 4 effectively prevents food debris, liquid, and the like from scattering outside the pet mat area, thereby maintaining the cleanliness of the surrounding environment. For example, in pet feeding scenarios, the protruding barrier rim 4 prevents overflow of food debris and liquid, and avoids contamination of the floor and other items; and in pet resting scenarios, the protruding barrier rim 4 prevents pet hair, dander, and the like from scattering, thereby facilitating cleaning and maintenance.

### Example 10

With reference to FIG. 15, in this example, the detachable protruding barrier rim 4 is arranged along a circumferential edge of the lower layer 2. In specific implementation, the protruding barrier rim 4 is made from a flexible material such as waterproof fabric or plastic sheets, and is generally 0.5-2 mm thick, exhibiting good flexibility and waterproof performance. The protruding barrier rim 4 is fixed to a reserved interface at the edge of the lower layer 2 through an embedded plug-in connection, adhesive bonding, a snap-fit connection, or the like. The reserved interface is designed as a standardized slot or an adhesive area to ensure secure installation and convenient removal of the protruding barrier rim 4. The protruding barrier rim 4 is typically 3-10 cm high, which effectively prevents the overflow of liquid and solid particles.

In actual use, when the pet feeds or rests on the mat, the protruding barrier rim 4 effectively prevents food debris, liquid, and the like from scattering outside the pet mat area, thereby maintaining the cleanliness of the surrounding environment. The detachable design of the protruding barrier rim 4 provides the user with a more flexible usage experience. To clean the protruding barrier rim 4, the user only needs to gently press the snap-fit structure or peel off an adhesive portion to remove the protruding barrier rim 4 from the edge of the lower layer 2. After cleaning, the protruding barrier rim 4 is reinstalled onto the reserved interface, to ensure the normal use of the pet mat. Additionally, the user chooses whether to install the protruding barrier rim 4 according to different usage scenarios, that is, the protruding barrier rim 4 is removed in a space-limited area to save space.

The design of the detachable protruding barrier rim 4 further enhances the adaptability and practicality of the pet mat. The user flexibly chooses whether to install or remove the protruding barrier rim 4 according to the pet's behavior habits or home environment, to maximize the functionality of the pet mat.

### Example 11

With reference to FIG. 16, in this example, a protrusion 12 configured for area separation is arranged on the upper layer 1. In this example, the protrusion 12 divides the pet mat into different functional areas, which enhances usability and functionality of the pet mat.

In specific implementation, the protrusion 12 is made from a flexible material such as silicone, plastic, or a fabric-filled material to ensure comfort and safety of the pet. The protrusion 12 is typically 3-10 cm high and 2-5 cm wide, and the height and width are adjustable based on actual needs. The protrusion 12 is fixed to the surface of the upper layer 1 through sewing, adhesive bonding, snap-fit connection, or the like, to form different functional areas. For example, the protrusion 12 is arranged on one side of the pet mat to demarcate a relatively independent feeding area 13, and a resting area 14 is arranged on the other side of the pet mat. The protrusion 12 not only prevents food and liquid from scattering into the resting area 14 during pet activity, but also guides the pet to feed or rest in a designated area.

In actual use, when the pet feeds in the feeding area 13, the protrusion 12 effectively blocks diffusion of food debris and liquid towards the resting area 14, thereby maintaining the cleanliness and dryness of the resting area 14. Similarly, when the pet rests in the resting area 14, the protrusion 12 prevents pet hair, dander, and the like from entering the feeding area 13, which facilitates cleaning and maintenance.

Furthermore, the area separation design is also suitable for multi-pet households, which allows each pet to enjoy an independent functional area, thereby minimizing mutual interference.

Moreover, the arrangement of the protrusion 12 achieves a certain guiding and signaling effect. For example, different shapes or colors of side faces of the protrusion 12 help the pet to recognize different functional areas and cultivate desirable behavioral habits. Moreover, the protrusion 12 enhances the visual dimensionality and aesthetic appeal of the pet mat.

### Example 12

With reference to FIGS. 17 and 18, in this example, the non-detachable protrusion 12 configured for area separation is arranged on the lower layer 2. The protrusion 12 designed divides the pet mat into two functional areas, which allows the user to flexibly replace a thermal insulation unit or a heat dissipation unit according to seasonal changes or pet requirements to adapt to different environmental conditions.

In specific implementation, the lower layer 2 is made from a rigid material, such as silicone.

As shown in FIG. 17, the upper layer 1 is of an integral structure. Alternatively, as shown in FIG. 18, the upper layer 1 is composed of two functional units 101: a waterproof unit and a thermal insulation unit. The waterproof unit is made from a waterproof fabric material such as a PVC-coated fabric material or a TPU composite fabric material, and the waterproof fabric material with excellent waterproof properties is used to form the feeding area for the pet. The thermal insulation unit is made from a plush material such as polyester fleece or polypropylene fleece, and the plush material has good thermal insulation properties and is used to form the resting area for the pet, which is particularly suitable for use in winter or cold conditions.

In actual use, the waterproof unit is placed on one side of the protrusion 12 to form the feeding area 13 for the pet. After feeding of the pet, the user removes the waterproof unit from the lower layer 2 for cleaning. The cleaned waterproof unit is re-combined with the lower layer 2 without need to replace the entire pet mat, thereby saving usage costs.

The thermal insulation unit is placed on the other side of the protrusion 12 to form the resting area 14 for the pet, which provides a warm and comfortable resting environment for the pet. To adapt to summer or high-temperature conditions, or heat-sensitive pets such as Alaskan Malamutes, the thermal insulation unit is replaced with the heat dissipation unit as needed. The heat dissipation unit is made from a breathable mesh fabric or gel material that has excellent heat dissipation properties, such that the functionality of the resting area 14 for the pet is maintained while meeting the pets' needs for different seasons or environments.

### Example 13

With reference to FIGS. 19 and 20, in this example, the pet mat is placed inside a pet enclosure and is primarily configured to meet the feeding and drinking needs of the pet. The pet enclosure is designed to provide a relatively independent activity space for the pet, which facilitates the guidance and restriction of pet behaviors, prevents the pet from running freely, and enables efficient feeding and drinking management. The protrusion 12 divides the pet mat into a dry area and a wet area, thereby preventing mutual interference and contamination. The wet area is configured for water drinking, and the dry area is configured for placing dry food and the like, which prevents moisture-induced spoilage of dry food and ensures the pet health.

In the design of the pet mat, the upper layer 1 of a drinking area is made from an absorbent material. The absorbent material absorbs moisture, maintains surface dryness of the drinking area, and prevents water spillage from wetting the surrounding environment when the pet drinks water. The use of the absorbent material reduces the risk of slipping when the pet steps over water, minimizes safety hazards of slipping for the owner, and prevents contamination of surrounding areas by water stains. The use of the absorbent material allows for effective water absorption, which prevents pet toys from getting wet and avoids the proliferation of bacteria and mold on the toys. Particularly for toys with sound-emitting devices, the absorbent material prevents water from entering air holes of the sound-emitting device, which increases difficulty of cleaning due to water accumulation and reduces the illness risk of the pet due to growth of bacteria and mold. Additionally, the use of the absorbent material keeps the resting area dry, and prevents growth of bacteria and mold in a humid environment, thereby decreasing the likelihood of skin diseases of the pet.

However, it is to be noted that the absorbent material needs to be cleaned frequently, and when the upper layer 1 is made from an absorbent material and the lower layer 2 is made from a waterproof material, it is ensured that water does not flow into the indoor floor.

Alternatively, the upper layer 1 of the drinking area is made from a waterproof material. As shown in FIG. 20, the waterproof material is used in combination with the protruding barrier rim 4, and the protruding barrier rim 4 higher than the upper layer 1 actually forms a waterproof enclosure. The waterproof material effectively prevents water in the drinking area from penetrating into the lower layer 2 or the floor, and confines water to the upper layer 1 of the drinking area. Thus, any water splashed by the pet during drinking does not penetrate to the lower layer 2 or the floor, which avoids wetting of the resting and activity areas for the pet, thereby maintaining a dry and clean environment. The use of the waterproof material also prevents occurrence of paronychia and other diseases of the pet caused by stepping in water, and avoids water transfer to other areas, which causes possible slip of the owner or environmental contamination by water stains. Additionally, the waterproof material facilitates cleaning and maintenance, and it is required to remove water only on the upper layer 1 of the drinking area and the surface of the pet mat, without need to worry about water penetration to the lower layer 2 or the floor, thereby protecting flooring materials and other structures. The protruding barrier rim 4 forms a barrier structure that confines water to the drinking area, thereby preventing overflow. Some water left after the pet finishes drinking remains inside the barrier structure and doesn't easily spill out, which further maintains the dryness and cleanliness of the surrounding environment. In this way, the waterproof material prevents pet toys from getting wet, prevents growth of bacteria and mold, protects sound-emitting devices of the pet toys from water damage, reduces the illness risk of the pet, keeps the resting area dry, and prevents growth of bacteria and mold in a humid environment, thereby decreasing the likelihood of skin diseases of the pet.

However, it is to be understood that the use of the waterproof material does not prevent the pet from directly standing in the drinking area, that is, contact with water is not avoided. An appropriate-sized pet mat is selected for a large pet to prevent the large pet from standing or stepping into the drinking area.

### Example 14

With reference to FIGS. 21-23, in this example, the pet mat is placed inside a pet enclosure or a pet cage (the pet enclosure is shown in the figure), an overall size of the pet mat matches internal dimensions of the pet enclosure or the pet cage, and the pet mat covers most surfaces of the pet enclosure or the pet cage. Such design is intended to provide the pet with a complete and clearly-defined living space. The protrusion 12 divides the pet mat into different functional areas, including the resting area and the feeding area. The feeding area is configured to meet the feeding and drinking needs of the pet, and the resting area is a secure place for the pet to rest, and is clearly separated from the feeding area through the protrusion 12.

The resting area, as an exclusive resting space for the pet, is clearly separated from the feeding area, thereby remaining dry and hygienic. When resting, the pet is not affected by moisture and food debris in the feeding area, thereby reducing the risk of skin diseases caused by a humid environment, and providing a comfortable and healthy resting space for the pet. Dry food and other items for the pet are placed in the feeding area, and the upper layer 1 is made from the absorbent or waterproof material. The absorbent material absorbs moisture, maintains surface dryness of the drinking area, reduces the risk of slipping when the pet steps over water, and prevents water from spreading to other areas. The waterproof material effectively prevents water in the drinking area from penetrating into the lower layer 2 or the floor, confines water to the drinking area, facilitates cleaning and maintenance, and protects flooring materials and other structures.

The protrusion 12 as a separation structure of the pet mat not only divides different functional areas, but also constrains water and food in designated areas. Such design allows the pet to rest in a clearly defined resting area on the pet mat and feed or drink in the feeding area, thereby maintaining the dryness and hygiene of the resting area, improving the living quality of the pet, and facilitating the management and cleaning of the pet's living space by the owner.

Exemplary examples of the present disclosure have been described, those skilled in the art should understand that various modifications and variations to the exemplary examples of the present disclosure may be made without departing from the spirit and scope of the present disclosure. Therefore, all such modifications and variations fall within the protection scope defined by the appended claims of the present disclosure. The present disclosure is defined by the appended claims and equivalents of these claims are also included.

What is claimed is:

1. A composite-structured pet mat, comprising an upper layer and a lower layer separable from each other, wherein the upper layer is of an integral structure or formed by splicing or combining at least two functional units.

2. The composite-structured pet mat according to claim 1, wherein a method for connection between the upper layer and the lower layer comprises but is not limited to at least one of magnetic fit, a snap-fit structure, a clamping component, a strap, or a reusable adhesive structure.

3. The composite-structured pet mat according to claim 1, wherein the upper layer and the lower layer are cooperatively magnetically connected, and magnetic elements with opposite magnetic polarities are arranged at corresponding positions of the upper layer and the lower layer, comprising but not limited to magnetic blocks, magnetic strips, or magnetic composite materials.

4. The composite-structured pet mat according to claim 1, wherein the lower layer is made from a magnetic waterproof material, and a bottom of the upper layer is provided with a metal sheet or a magnetic element with a magnetic polarity complementary to that of the lower layer to achieve adsorptive fixation with the lower layer.

5. The composite-structured pet mat according to claim 3, wherein the upper layer and the lower layer are cooperatively connected through a snap-fit structure, a plurality of slots and hook assemblies fitted with each other are arranged along edges of the upper layer and the lower layer, and multi-point snap-fit engagement achieves a cooperative connection between the upper layer and the lower layer.

6. The composite-structured pet mat according to claim 1, wherein the upper layer and/or the lower layer is provided with a protrusion configured for spatial separation.

7. The composite-structured pet mat according to claim 6, wherein the protrusion is a detachable partition strip.

8. The composite-structured pet mat according to claim 7, wherein the partition strip is fixed to the upper layer and/or the lower layer through embedded plug-in connection or adhesive bonding.

9. The composite-structured pet mat according to claim 1, wherein the functional units comprise, but are not limited to, one or more of a waterproof unit, a water-absorbing unit, a heat-conducting unit, and a thermal insulation unit.

10. The composite-structured pet mat according to claim 1, wherein the functional units are detachably connected to each other through at least one of magnetic fit, a snap-fit structure, a clamping component, or a reusable adhesive structure, such that localized replacement or functional recombination of the upper layer is achieved according to usage requirements.

11. The composite-structured pet mat according to claim 1, wherein the lower layer is a waterproof layer with water-resistant properties.

12. The composite-structured pet mat according to claim 1, wherein the upper layer is provided with a protruding barrier rim, and the protruding barrier rim is a continuously enclosed barrier configured to prevent liquid overflow and solid particle migration out of a pet mat area, or alternatively is a blocking structure arranged at a local position or in a specific direction.

13. The composite-structured pet mat according to claim 1, wherein the lower layer is provided with a protruding barrier rim, and the protruding barrier rim is a continuously enclosed barrier configured to prevent liquid overflow and solid particle migration out of a pet mat area, or alternatively is a blocking structure arranged at a local position or in a specific direction.

14. The composite-structured pet mat according to claim 13, wherein the protruding barrier rim is detachably arranged on the lower layer, and removal of the protruding barrier rim for cleaning or replacement is allowed.

15. The composite-structured pet mat according to claim 13, wherein the protruding barrier rim is arranged on the lower layer and forms a circumferential constraint structure together with a bottom face of the upper layer, which is configured to fix relative positions of the upper layer and the lower layer and achieve a separable cooperative connection between the upper layer and the lower layer.

16. The composite-structured pet mat according to claim 1, wherein the upper layer is made from one or more of fabric, silicone, a superabsorbent polymer, sponge, diatom mud, a natural fiber, and an artificial fiber.

17. The composite-structured pet mat according to claim 1, wherein the lower layer is made from one or more materials comprising but not limited to silicone, a high-molecular polymer, leather, artificial leather, rubber, plastic, ethylene-vinyl acetate copolymer, polyvinyl chloride, a polyurethane-coated material, a waterproof textile material, polyethylene, and polypropylene, and the materials are used individually or in combination to achieve waterproof functionality of the lower layer.

18. The composite-structured pet mat according to claim 1, wherein support contact bodies that are spaced apart from each other are arranged on an upper surface of the lower layer, and support planes are formed at tops of the support contact bodies.

19. The composite-structured pet mat according to claim 18, wherein the support contact bodies are elastic structures configured to achieve pressure cushioning and enhance comfort.

20. The composite-structured pet mat according to claim 18, wherein the lower layer is provided with a continuously enclosed protruding barrier rim surrounding the support contact bodies, such that the lower layer has a certain liquid storage capacity.
